(19) United States
(12) Patent Application Publication
(10) Pub. No.: US 2026/0158937 A1
(43) Pub. Date: Jun. 11, 2026

(54) TRAIN INFORMATION MANAGEMENT DEVICE, TEST TERMINAL DEVICE, TRAIN INFORMATION MANAGEMENT DEVICE TESTING SYSTEM, AND TEST METHOD

(71) Applicant: Mitsubishi Electric Corporation, Chiyoda-ku, Tokyo (JP)

(72) Inventors: Akemi KANEMATSU, Tokyo (JP); Shogo TATSUMI, Tokyo (JP)

(73) Assignee: Mitsubishi Electric Corporation, Chiyoda-ku, Tokyo (JP)

(21) Appl. No.: 18/710,391

(22) PCT Filed: Dec. 20, 2021
(86) PCT No.: PCT/JP2021/047013

§ 371 Date: May 15, 2024

(51) Int. Cl. B60L 15/40; B60L 3/00

(52) U.S. Cl. CPC B60L 15/40; B60L 3/00

(57) ABSTRACT

A train information management device includes at least one computation processing unit, a data management unit that stores a first combination, which includes information that enables identification of a variable and a value of a first variable, an input data management unit that stores a second combination, which is obtained from the test terminal device and includes the information that enables identification of the variable and a value of a second variable, a variable selection unit that selects, based on the operation mode of the train information management device, either the value of the first variable or the value of the second variable, and a data acquiring and setting unit that specifies the information that enables identification of the variable to the variable selection unit, obtains the value of the variable selected, and sets the value of the variable obtained, to the computation processing unit.

### FIELD

The present disclosure relates to a train information management device to be installed on a train, and to a test terminal device, a train information management device testing system, and a test method.

### BACKGROUND

A train information management device to be installed on a train conventionally has multiple computational functions and exchanges data between the computational functions using variables to thereby perform various processing. These computational functions are tested in such a manner that a value is set to an input variable of a computational function under test, and a check is then made on a value of an output variable that has been set by the computational function under test. In this respect, if the input variable of the computational function under test is overwritten by a computational function other than the computational function under test, such test will fail to be accomplished as intended. The input variable can avoid having an unintended value by modification such as modification to suspend the operation of the computational functions other than the computational function under test. This will however need modification of the software under test for purposes of testing, which is time consuming and requires effort, and moreover, prevents guaranteeing the sameness between the software after the modification and the software under test.

To address such problem, Patent Literature 1 discloses a technology in which an image generation device has normal image generation mode and debug mode, and verifies operation in debug mode using test data that has been stored in advance.

### CITATION LIST

### Patent Literature

Patent Literature 1: Japanese Patent Application Laid-open No. 2012-32567

### SUMMARY OF INVENTION

### Problem to be Solved by the Invention

However, according to the foregoing conventional technology, switching means included in the image generation device switches the mode between normal image generation mode and debug mode. Allowing a train information management device also to similarly switch the mode may allow the train information management device to unexpectedly switch the mode during running of the train, thereby presenting a problem in that the operation of the train may be affected. In addition, the foregoing conventional technology requires test data to be stored in advance. Thus, when the data for use in a test needs to be changed to desired data, the stored data needs to be changed. This presents a problem in being time consuming and requiring effort.

The present disclosure has been made in view of the foregoing, and it is an object of the present disclosure to provide a train information management device that allows a desired test to be performed without changing the configuration of software under test and without affecting the operation of a train.

### Means to Solve the Problem

In order to solve the above-described problems and achieve the object, a train information management device according to the present disclosure undergoes a test conducted by a test terminal device. The train information management device includes: at least one computation processing unit to perform computation processing using a value of a variable; a data management unit to store a first combination, the first combination including a variable name or information that enables identification of a variable and a value of a first variable, the value of the first variable being the value of the variable; an input data management unit to store a second combination, the second combination being obtained from the test terminal device and including the variable name or the information that enables identification of the variable and a value of a second variable, the value of the second variable being the value of the variable; an operation mode management unit to manage an operation mode of the train information management device; a variable selection unit to select, based on the operation mode, either the value of the first variable or the value of the second variable as the value of the variable; and a data acquiring and setting unit to specify the variable name or the information that enables identification of the variable to the variable selection unit, to obtain, from the variable selection unit, the value of the variable selected, and to set the value of the variable obtained, to the computation processing unit.

### Effects of the Invention

A train information management device of the present disclosure provides an advantage in allowing a desired test to be performed without changing the configuration of software under test and without affecting the operation of a train.

### BRIEF DESCRIPTION OF DRAWINGS

FIG. 1 is a diagram illustrating an example configuration of a train including a train information management device according to a first embodiment.

FIG. 2 is a diagram illustrating an example of computation processing performed in the train information management device according to the first embodiment.

FIG. 3 is a diagram illustrating an example configuration of a train information management device testing system according to the first embodiment.

FIG. 4 is a block diagram illustrating example configurations of the train information management device and of a test terminal device according to the first embodiment.

FIG. 5 is a diagram illustrating example configurations of a data management unit and of an input data management unit included in the train information management device according to the first embodiment.

FIG. 6 is a diagram illustrating an example of test script stored in a test conduction management unit of the test terminal device according to the first embodiment.

FIG. 7 is a diagram for describing operations when a test is being conducted by the test terminal device, in the train information management device according to the first embodiment.

FIG. 8 is a flowchart illustrating an operation of an operation mode management unit of the train information management device according to the first embodiment.

FIG. 9 is a flowchart illustrating an operation of an input data management unit of the train information management device according to the first embodiment.

FIG. 10 is a flowchart illustrating an operation of a computation processing unit of the train information management device according to the first embodiment.

FIG. 11 is a flowchart illustrating an operation of a data acquiring and setting unit of the train information management device according to the first embodiment.

FIG. 12 is a flowchart illustrating an operation of a variable selection unit of the train information management device according to the first embodiment.

FIG. 13 is a flowchart illustrating an operation of the test terminal device according to the first embodiment.

FIG. 14 is a diagram illustrating an example of configuration of a processing circuitry that implements the train information management device according to the first embodiment when the processing circuitry is implemented by a processor and a memory.

FIG. 15 is a diagram illustrating an example of configuration of a processing circuitry that implements the train information management device according to the first embodiment when the processing circuitry is formed using a dedicated hardware element.

FIG. 16 is a diagram illustrating an illustrative image of variables stored in the input data management unit of the train information management device according to a second embodiment.

FIG. 17 is a diagram illustrating an example of relationships between types of devices and identifiers (IDs) for use in a tag, where the type of device is a parameter used in the tag processed by the train information management device according to the second embodiment.

FIG. 18 is a diagram illustrating an example of relationships between variable names associated with a propulsion control device and IDs for use in a tag, where the variable name is a parameter used in the tag processed by the train information management device according to the second embodiment.

FIG. 19 is a diagram illustrating an example of relationships between variable names associated with a brake control device and IDs for use in a tag, where the variable name is a parameter used in the tag processed by the train information management device according to the second embodiment.

FIG. 20 is a flowchart illustrating an operation of the input data management unit of the train information management device according to the second embodiment.

FIG. 21 is a flowchart illustrating an operation of the variable selection unit of the train information management device according to the second embodiment.

FIG. 22 is a diagram illustrating an example configuration of a train information management device testing system according to a third embodiment.

FIG. 23 is a diagram illustrating an example configuration of a train information management device testing system according to a fourth embodiment.

FIG. 24 is a block diagram illustrating example configurations of the train information management device, a test terminal device, and a terminal device according to the fourth embodiment.

### DESCRIPTION OF EMBODIMENTS

A train information management device, a test terminal device, a train information management device testing system, and a test method according to embodiments of the present disclosure will be described in detail below with reference to the drawings.

### First Embodiment

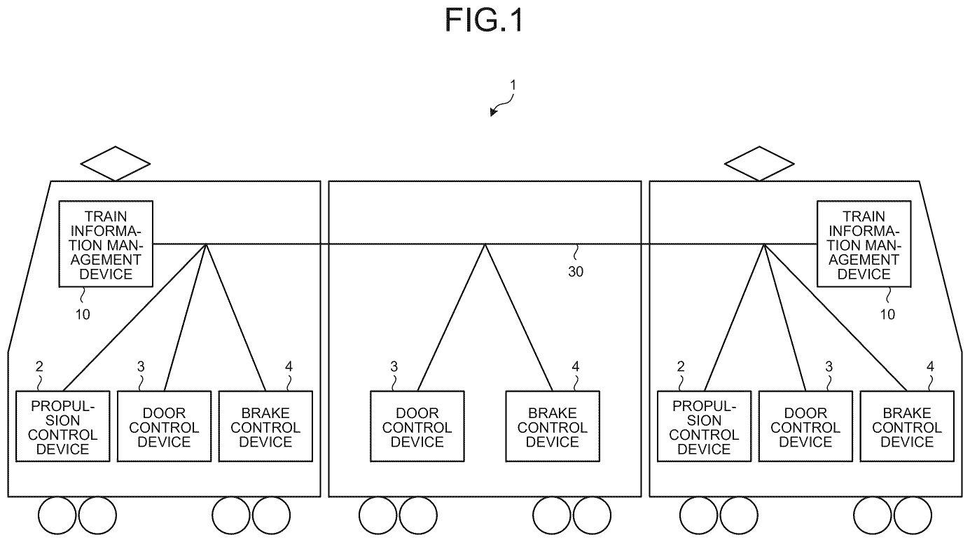

FIG. 1 is a diagram illustrating an example configuration of a train 1 including at least one train information management device 10 according to a first embodiment. The train 1 includes the train information management device 10. The train information management device 10 is connected to devices installed on the train 1, such as a propulsion control device 2, a door control device 3, and a brake control device 4 via an intra-train network 30 to monitor and control these devices. The train information management device 10 obtains information about states of devices such as the propulsion control device 2, the door control device 3, and the brake control device 4 via the intra-train network 30, and sends a result of performing necessary computation processing to the devices via the intra-train network 30 to thereby control these devices. The train information management device 10 is installed, in general, on vehicles such as the lead vehicle and the last vehicle, on which a cab (not illustrated) and the like are installed in the train 1. The number of the train information management devices 10 to be installed on the train 1 is, however, not limited to two as illustrated in FIG. 1.

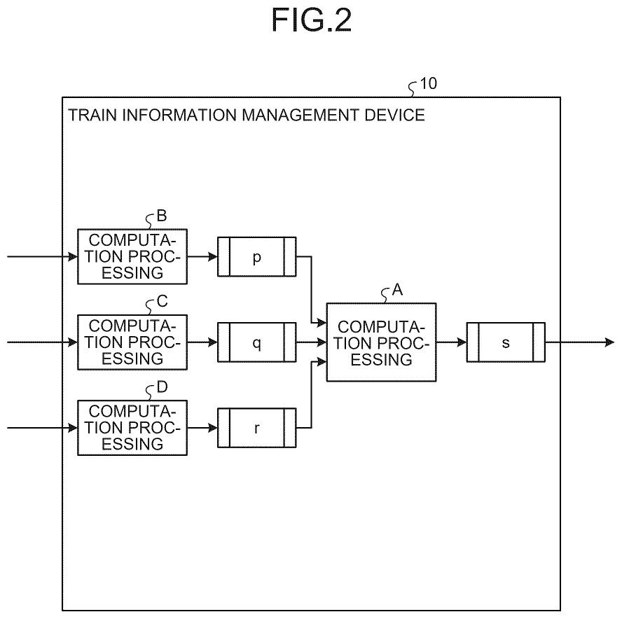

Computation processing performed in the train information management device 10 will now be described. FIG. 2 is a diagram illustrating an example of computation processing performed in the train information management device 10 according to the first embodiment. Computation processing performed in the train information management device 10 may be divided into multiple computation processings internally in the train information management device 10. FIG. 2 illustrates the multiple computation processings as computation processings A to D. The computation processings A to D each have a function to obtain a value that has been set to a specific variable, as input data, to set a value to another variable, and to thus output the value of the another variable as output data, i.e., as a result of that computation processing. The train information management device 10 allows data to be provided to and received from computation processing in such a manner that output data that is a result of computation processing from specific computation processing is used as input data to another computation processing.

FIG. 2 illustrates an example in which computation processing B sets output data to a variable “p”, computation processing C sets output data to a variable “q”, and computation processing D sets output data to a variable “r”. Computation processing A obtains input data from the variables p, q, and r, and sets output data to a variable “s”.

FIG. 2 illustrates a situation in which the input data to computation processings B, C, and D are obtained from outside the train information management device 10, that is, via the intra-train network 30. FIG. 2 also illustrates a situation in which the variable s has output data that has been set in computation processing A, and is output to outside the train information management device 10, that is, via the intra-train network 30. As illustrated in FIG. 2, the train information management device 10 uses the results of computation processings of computation processings B, C, and D as the input data to computation processing A via the variables p, q, and r. Each of the computation processings is implemented in software on a processor, in the processor or the like included in the train information management device 10.

In this respect, computation processing A is tested in the train information management device 10 by checking whether the value of the output data has an expected value for values that can be given as the input data to computation processing A. Specifically, computation processing A is tested in such a manner that values are set to the variables p, q, and r, which are input data to computation processing A; the value of the variable s is read, to which the output data, i.e., the result of computation processing of computation processing A, has been set; and it is checked whether the value of the variable s is equal to an expected value. To this end, the train information management device 10 has a mechanism to allow the values of the variables p, q, and r to be changed according to an external command.

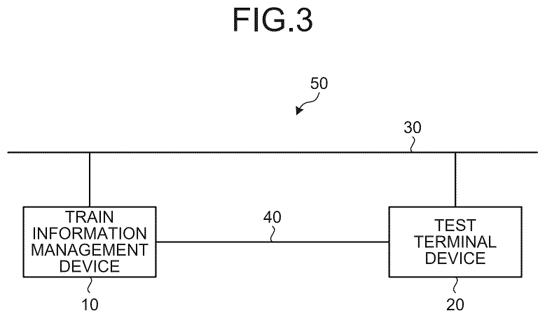

A specific configuration for testing the train information management device 10 will next be described. FIG. 3 is a diagram illustrating an example configuration of a train information management device testing system 50 according to the first embodiment. The train information management device testing system 50 includes the train information management device 10, a test terminal device 20, the intra-train network 30, and a test communication line 40. The train information management device testing system 50 is a system in which the test terminal device 20 tests the train information management device 10. The train information management device 10 is tested by the test terminal device 20. In the train information management device testing system 50, the train information management device 10 and the test terminal device 20 are connected to each other by the intra-train network 30 and by the test communication line 40. The test terminal device 20 sends a combination of a variable name and a value of a variable to the train information management device 10 using the test communication line 40 to thereby rewrite the value of the variable stored in the train information management device 10. The test terminal device 20 is also capable of referring to data being transmitted on the intra-train network 30.

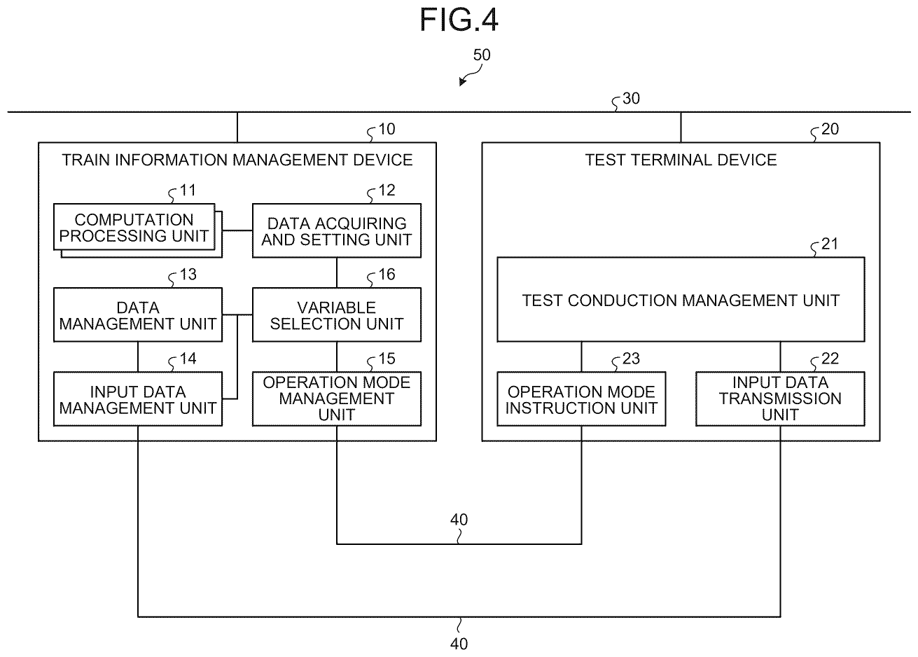

FIG. 4 is a block diagram illustrating example configurations of the train information management device 10 and of the test terminal device 20 according to the first embodiment. The train information management device 10 includes a computation processing unit 11, a data acquiring and setting unit 12, a data management unit 13, an input data management unit 14, an operation mode management unit 15, and a variable selection unit 16. The test terminal device 20 includes a test conduction management unit 21, an input data transmission unit 22, and an operation mode instruction unit 23. Note that multiple test communication lines 40 may be used as illustrated in FIG. 4, or a single test communication line 40 may be shared as illustrated in FIG. 3.

The computation processing unit 11 performs computation processing using a value of a variable. Specifically, in the computation processing, the computation processing unit 11 specifies a variable name to the data acquiring and setting unit 12 to thus request a value of a variable associated with that variable name, and performs computation processing using, as input data thereto, the value of the variable that has been set by the data acquiring and setting unit 12. Note that the train information management device 10 includes one or more computation processing units 11, and each of the computation processing units 11 corresponds to one computation processing illustrated in FIG. 2.

The data acquiring and setting unit 12 specifies a variable name to the variable selection unit 16 based on a request from the computation processing unit 11 to thus request a value of a variable. The data acquiring and setting unit 12 obtains, from the variable selection unit 16, a value of a variable selected by the variable selection unit 16, and sets the value of the variable obtained, to the computation processing unit 11.

The data management unit 13 stores the value of the variable to be processed by each of the computation processing units 11 of the train information management device 10. The data management unit 13 stores first combinations, each of which includes a variable name and a value of a first variable, which is a value of a variable.

The input data management unit 14 stores combinations each including a variable name and a value of a variable, as input data to be provided to one under test of the computation processing units 11 (hereinafter referred to simply as the computation processing unit 11 under test), sent from the test terminal device 20. The input data management unit 14 stores second combinations, which are obtained from the test terminal device 20 and each of which includes a variable name and a value of a second variable, which is a value of a variable.

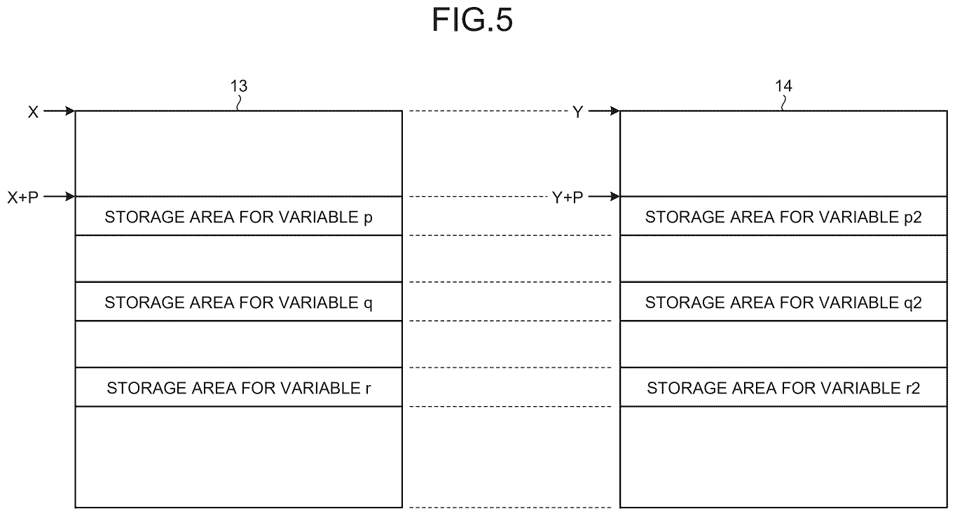

Configurations of the data management unit 13 and of the input data management unit 14 will next be described. FIG. 5 is a diagram illustrating example configurations of the data management unit 13 and of the input data management unit 14 included in the train information management device 10 according to the first embodiment. Let X denote the top address of the data storage area for storing variables to be managed by the data management unit 13. The input data management unit 14 reserves a data storage area having a same structure as the structure of the data management unit 13 to prevent the data storage area thereof from overlapping the data storage area of the data management unit 13. For example, let Y denote the top address of the data storage area for storing variables to be managed by the input data management unit 14. The input data management unit 14 has an area for storing the values of the variables respectively corresponding to the values of the variables managed by the data management unit 13 to have an address relatively the same as the address relative to the top address of the area in which the values of the variables are managed by the data management unit 13. For example, when the area for storing the value of the variable p in the data management unit 13 has an address X+P, the input data management unit 14 uses an address Y+P for the area for storing the value of a variable p2, which corresponds to the value of the variable p in the input data management unit 14.

Returning to the description with reference to FIG. 4, the operation mode management unit 15 manages the operation mode of the train information management device 10 according to a command of operation mode from the test terminal device 20. The train information management device 10 has operation modes of test mode when a test of the train information management device 10 is conducted and normal mode when a test of the train information management device 10 is not conducted. The operation mode management unit 15 receives a notification of test mode when a test is conducted and a notification of normal mode when a test is not conducted, as a notification of the operation mode of the train information management device 10.

The variable selection unit 16 selects, and thereby obtains, the value of a variable associated with the variable name specified by the data acquiring and setting unit 12 from either the data management unit 13 or the input data management unit 14, based on the operation mode of the train information management device 10, managed by the operation mode management unit 15. The variable selection unit 16 selects, as the value of the variable, either the value of the first variable stored in the data management unit 13 or the value of the second variable stored in the input data management unit 14, based on the operation mode. Specifically, the variable selection unit 16 selects the value of the first variable stored in the data management unit 13 in normal mode as the value of the variable, and selects the value of the second variable stored in the input data management unit 14 in test mode as the value of the variable.

The test conduction management unit 21 stores input-output data as a test script including changes in time series for use in a test, where the input-output data is a set of combinations each including a variable name and a value of a variable, and expected values, where the combinations are for use as the input data to the computation processing unit 11 under test in the train information management device 10, and the expected values are expected values of the output data from that computation processing unit 11. The test conduction management unit 21 conducts a test on the train information management device 10 using a test script. The test conduction management unit 21 rewrites, according to the description of the test script, the value(s) of the variable(s) to be input to the computation processing unit 11 that is to be tested in the train information management device 10, and obtains the value of the variable to which a result of computation processing from the computation processing unit 11 under test has been set. The test conduction management unit 21 checks whether the computation processing unit 11 is operating as expected by comparing the value of the variable obtained, to which a result of computation processing from the computation processing unit 11 has been set, with the expected value in the test script.

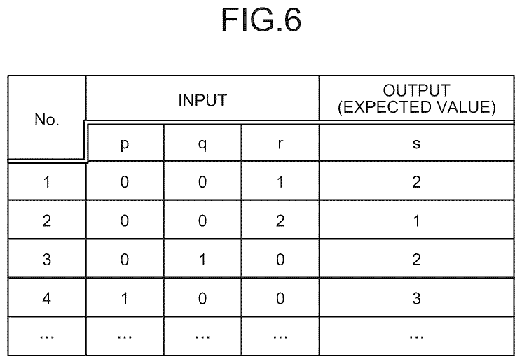

FIG. 6 is a diagram illustrating an example of the test script stored in the test conduction management unit 21 of the test terminal device 20 according to the first embodiment. For example, the test conduction management unit 21 sends values of p=0, q=0, and r=1 illustrated in the No. 1 row as the input data, i.e., the combinations each including a variable name and a value of a variable, from the test script illustrated in FIG. 6 to the train information management device 10 via the input data transmission unit 22. The test conduction management unit 21 determines that the computation processing unit 11 under test is operating as expected in the train information management device 10 when the value of the variable s, which is the output data from the train information management device 10, is equal to the expected value of 2. The test conduction management unit 21 determines that the computation processing unit 11 under test is not operating as expected in the train information management device 10 when the value of the variable s, which is the output data from the train information management device 10, is different from the expected value of 2. As described above, the test conduction management unit 21 stores the second combinations, each including a variable name and a value of a second variable, where the value of the second variable is a value of a variable for use in the computation processing to be performed when the train information management device 10 is tested. The test conduction management unit 21 thus controls the test of the train information management device 10.

The input data transmission unit 22 sends, under control of the test conduction management unit 21, a combination of a variable name and a value of a variable as the input data to be provided to the computation processing unit 11 under test depending on the state of performing the test in the train information management device 10. The input data transmission unit 22 thus causes data stored in the input data management unit 14 of the train information management device 10 to be changed. Thus, the input data transmission unit 22 sends the second combinations to the train information management device 10.

The operation mode instruction unit 23 notifies, under control of the test conduction management unit 21, the operation mode management unit 15 whether the train information management device 10 is being tested. Specifically, the operation mode instruction unit 23 notifies the operation mode management unit 15 that the operation mode is test mode when the train information management device 10 is being tested, and that the operation mode is normal mode when the train information management device 10 is not being tested. Thus, the operation mode instruction unit 23 notifies the train information management device 10 that the operation mode is test mode indicating that a test is being conducted when the test conduction management unit 21 tests the train information management device 10.

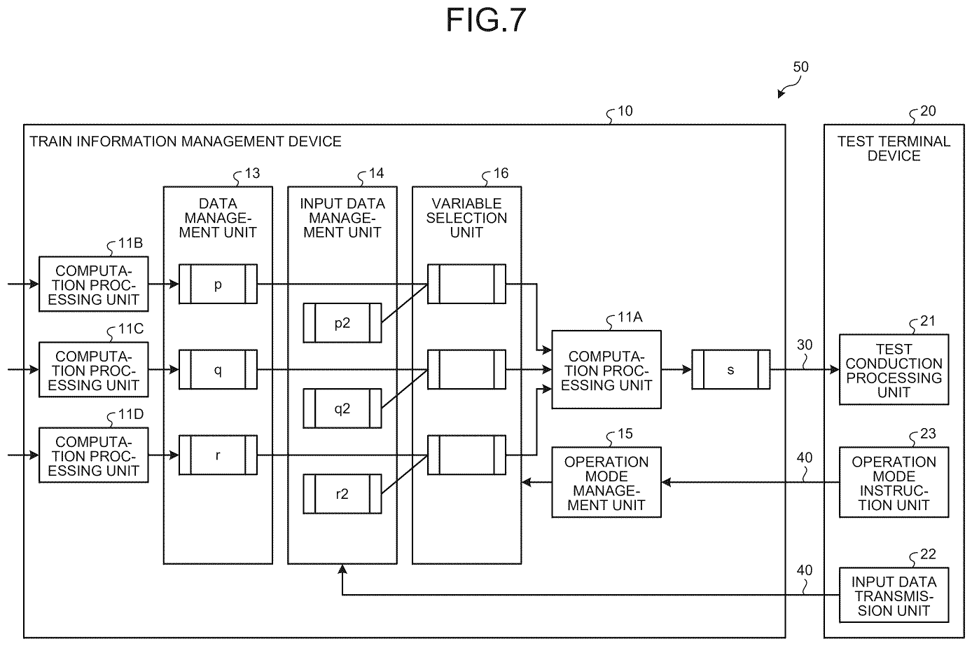

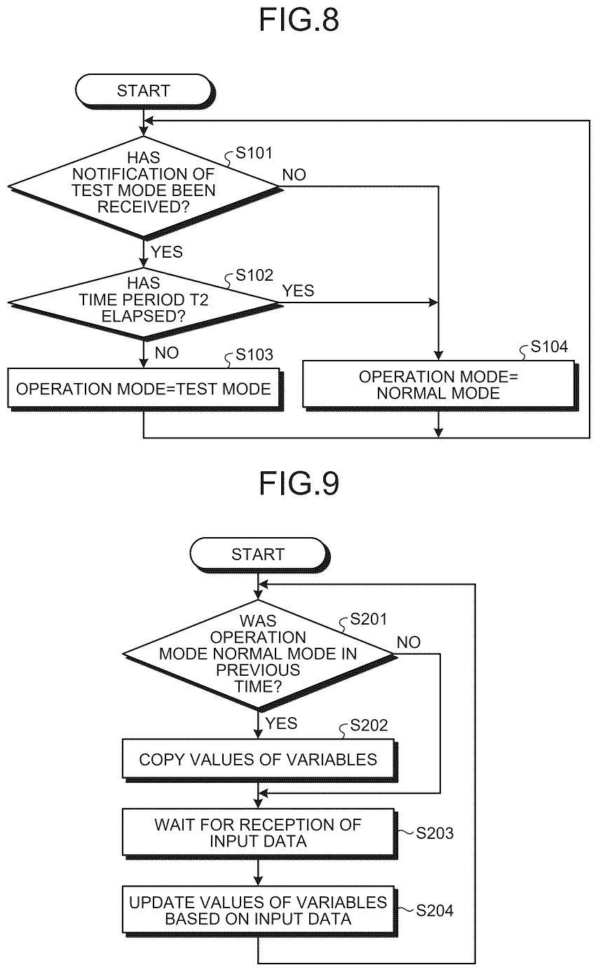

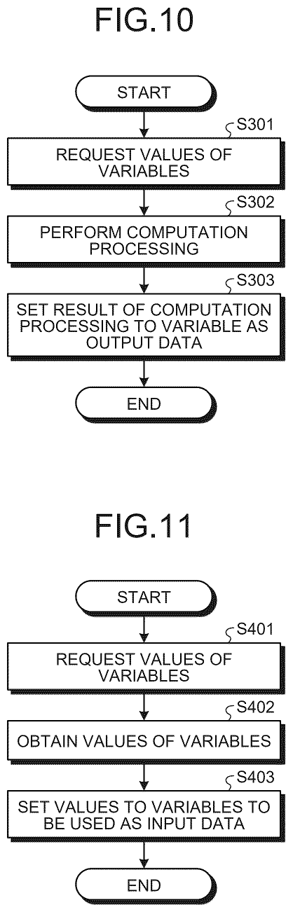

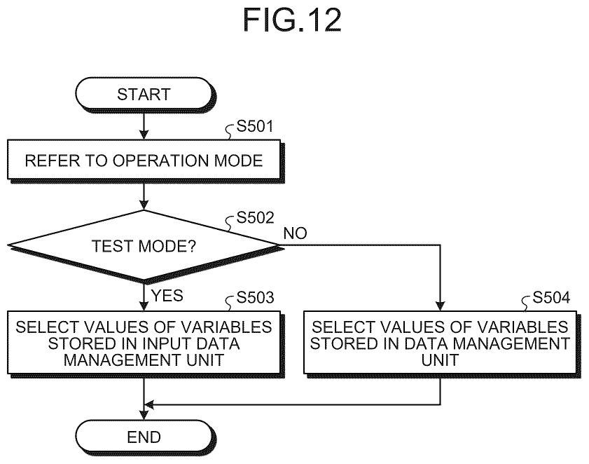

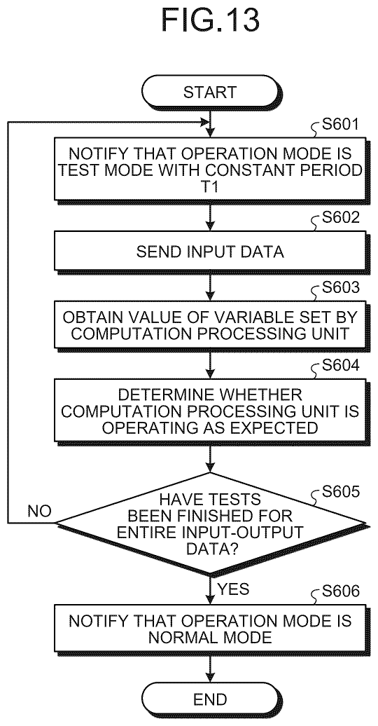

Operations of the train information management device 10 and of the test terminal device 20 will next be described. FIG. 7 is a diagram for describing operations when a test is being conducted by the test terminal device 20, in the train information management device 10 according to the first embodiment. In FIG. 7, computation processing units 11A to 11D are configured similarly to the computation processing unit 11 illustrated in FIG. 4. In addition, although the illustration is simplified in FIG. 7, the variable s, i.e., the area in which the value of the variable s is written, is in fact included in the data management unit 13 similarly to the case of other variables p, q, and r. FIG. 8 is a flowchart illustrating an operation of the operation mode management unit 15 of the train information management device 10 according to the first embodiment. FIG. 9 is a flowchart illustrating an operation of the input data management unit 14 of the train information management device 10 according to the first embodiment. FIG. 10 is a flowchart illustrating an operation of the computation processing unit 11 of the train information management device 10 according to the first embodiment. FIG. 11 is a flowchart illustrating an operation of the data acquiring and setting unit 12 of the train information management device 10 according to the first embodiment. FIG. 12 is a flowchart illustrating an operation of the variable selection unit 16 of the train information management device 10 according to the first embodiment. FIG. 13 is a flowchart illustrating an operation of the test terminal device 20 according to the first embodiment.

The test conduction management unit 21 of the test terminal device 20 receives an instruction to start a test of the train information management device 10 from a maintenance person or the like of the railroad company that operates the train 1. The test conduction management unit 21 controls the operation mode instruction unit 23 to cause the operation mode instruction unit 23 to notify the operation mode management unit 15 of the train information management device 10 that the operation mode is test mode with a constant period T1 (step S601).

The operation mode management unit 15 of the train information management device 10 maintains the operation mode of the train information management device 10 at test mode for a time period T2 after receiving a notification of test mode sent from the operation mode instruction unit 23 of the test terminal device 20. Note that the time period T2 is longer than one period of the constant period T1. When the time period T2 has elapsed since the last reception of notification of test mode, or when a notification of normal mode is received from the operation mode instruction unit 23 of the test terminal device 20, the operation mode management unit 15 sets the operation mode of the train information management device 10 at normal mode. As described above, the test terminal device 20 sends a notification of test mode with a predetermined period, and when the operation mode management unit 15 receives a notification of test mode, the operation mode management unit 15 maintains the operation mode of the train information management device 10 at test mode for a predetermined time longer than one period of a predetermined period.

The operation mode management unit 15 receives a notification of test mode from the operation mode instruction unit 23 of the test terminal device 20 (step S101: Yes), and when the time period T2 has not elapsed since the last reception of notification of test mode (step S102: No), the operation mode management unit 15 maintains the operation mode of the train information management device 10 at test mode (step S103). When the operation mode management unit 15 receives a notification of normal mode from the operation mode instruction unit 23 of the test terminal device 20 (step S101: No), the operation mode management unit 15 sets the operation mode of the train information management device 10 at normal mode (step S104). Alternatively, when the operation mode management unit 15 has received a notification of test mode from the operation mode instruction unit 23 of the test terminal device 20 (step S101: Yes) and the time period T2 has elapsed since the last reception of notification of test mode (step S102: Yes), the operation mode management unit 15 sets the operation mode of the train information management device 10 at normal mode (step S104).

When the operation mode of the train information management device 10 has changed from normal mode to test mode, this means that the operation mode was normal mode in the previous time (step S201: Yes), and the input data management unit 14 accordingly sets, that is, copies, the values of corresponding variables managed by the data management unit 13 as the values of all the variables to be managed by the input data management unit 14 (step S202). Note that when the operation mode was also test mode in the previous time (step S201: No), the input data management unit 14 skips the operation of step S202. In obtaining the operation mode of the train information management device 10, the input data management unit 14 may refer to the operation mode of the train information management device 10 managed by the operation mode management unit 15 via the variable selection unit 16, or may directly refer to the operation mode of the train information management device 10 managed by the operation mode management unit 15 although FIG. 4 omits illustration of connection relationship therebetween. This enables selection of values same as the values of the variables that have been used by the corresponding computation processing unit 11 in normal mode, thereby enabling the train information management device 10 to continue to operate correctly even when values of the variables managed by the input data management unit 14 have been selected to be used as the values of the variables for use by the computation processing unit 11 under test before combinations each including a variable name and a value of a variable are set to the input data management unit 14 from the test terminal device 20. As described above, when the operation mode has changed from normal mode to test mode, combinations each including a variable name and a value of a variable other than the second combinations obtained from the test terminal device 20 are obtained and stored such that the input data management unit 14 obtains the first combinations from the data management unit 13 and stores the first combinations. When the operation mode is test mode, the variable selection unit 16 selects values of the second variables stored in the input data management unit 14 or values of the first variables.

The test conduction management unit 21 of the test terminal device 20 selects one set of input-output data from the test script. For example, the input-output data of No.1 illustrated in FIG. 6 includes p=0, q=0, and r=1 specified as the input data and s=2 specified as the output data. The input data transmission unit 22 of the test terminal device 20 sends the input data of the set of the input-output data selected by the test conduction management unit 21 to the train information management device 10 (step S602). The input data sent from the input data transmission unit 22 is a list of combinations each including a variable name and a value of a variable, and is, for example, a set of (p, 0), (q, 0), and (r, 1) for the case of p=0, q=0, and r=1 given in the No.1 row illustrated in FIG. 6.

When the train information management device 10 is in test mode, the input data management unit 14 of the train information management device 10 waits for reception of the input data from the input data transmission unit 22 of the test terminal device 20 (step S203), and updates the values of the corresponding variables stored therein based on the input data sent from the input data transmission unit 22 of the test terminal device 20 (step S204). Specifically, the input data management unit 14 writes the values of the variables into the areas of variables p2, q2, and r2 corresponding to the input data, i.e., the combinations each including the variable name and the value of the variable. FIG. 7 denotes by p2, q2, and r2 the variables respectively corresponding to the variables p, q, and r and stored in the input data management unit 14 to distinguish the variables stored in the input data management unit 14 from the variables p, q, and r stored in the data management unit 13.

The computation processing unit 11A specifies variable names to the data acquiring and setting unit 12, and requests the values of the variables p, q, and r as the input data (step S301). Note that the illustration of FIG. 7 focuses on the operation of selection performed by the variable selection unit 16, and illustration of the data acquiring and setting unit 12 is accordingly omitted. In fact, however, the data acquiring and setting unit 12 is disposed between the computation processing unit 11A and the variable selection unit 16.

The data acquiring and setting unit 12 specifies variable names to the variable selection unit 16, and requests the values of the variables p, q, and r (step S401).

When the variable names are specified and the values of the variables p, q, and r are requested from the data acquiring and setting unit 12, the variable selection unit 16 refers to the operation mode of the train information management device 10 managed by the operation mode management unit 15 (step S501). When the train information management device 10 is in test mode (step S502: Yes), the variable selection unit 16 selects the values of the variables p2, q2, and r2 stored in the input data management unit 14 as the values of the variables p, q, and r (step S503). When the train information management device 10 is in normal mode (step S502: No), the variable selection unit 16 selects the values of the variables p, q, and r stored in the data management unit 13 as the values of the variables p, q, and r (step S504). The variable selection unit 16 outputs the values of the variables p, q, and r selected, to the data acquiring and setting unit 12 as the response to the request for the values of the variables p, q, and r made by the data acquiring and setting unit 12.

The data acquiring and setting unit 12 obtains the values of the variables p, q, and r from the variable selection unit 16 (step S402). The data acquiring and setting unit 12 sets the values of the variables p, q, and r obtained from the variable selection unit 16 to the variables p, q, and r to be used as the input data in the computation processing unit 11A as the response to the request for the values of the variables p, q, and r made by the computation processing unit 11A (step S403).

The computation processing unit 11A performs computation processing using the variables p, q, and r as the input data (step S302), and sets the result of the computation processing to the variable s as the output data (step S303). As described above, when the computation processing is performed using the values of the second variables as the values of the variables, the computation processing unit 11A sets the result of the computation processing to the variable s, from which the test terminal device 20 can obtain information of a value.

The test conduction management unit 21 of the test terminal device 20 obtains the value of the variable s that has been set by the computation processing unit 11A of the train information management device 10 via the intra-train network 30 (step S603). The test conduction management unit 21 compares the value of the variable s obtained, with an expected value to determine whether there is a match, that is, whether the computation processing unit 11A is operating as expected (step S604).

The test terminal device 20 and the train information management device 10 repeat the foregoing operations for the entire input-output data included in the test script stored in the test conduction management unit 21 of the test terminal device 20. That is, when the tests have not yet been finished for the entire input-output data included in the test script (step S605: No), the test conduction management unit 21 of the test terminal device 20 controls the operation mode instruction unit 23 to cause the operation mode instruction unit 23 to notify the operation mode management unit 15 of the train information management device 10 that the operation mode is test mode with the constant period T1 (step S601). When the tests have been finished for the entire input-output data included in the test script (step S605: Yes), the test conduction management unit 21 of the test terminal device 20 controls the operation mode instruction unit 23 to cause the operation mode instruction unit 23 to notify the operation mode management unit 15 of the train information management device 10 that the operation mode is normal mode (step S606).

A case will next be described in which connection between the test terminal device 20 and the train information management device 10 is disconnected during a test of the train information management device 10. The operation mode instruction unit 23 of the test terminal device 20 notifies the operation mode management unit 15 of the train information management device 10 that the operation mode is test mode with the constant period Tl as described above when the train information management device 10 is being tested. Disconnection of connection between the train information management device 10 and the test terminal device 20 prevents the operation mode management unit 15 from receiving a notification of test mode from the operation mode instruction unit 23. This enables the operation mode management unit 15 to switch the operation mode of the train information management device 10 from test mode to normal mode when at least the time period T2 has elapsed since the disconnection of connection between the train information management device 10 and the test terminal device 20.

A case will now be described in which, unlike the present embodiment, the area for use in storing the values of the variables is not changed depending on the operation mode of the train information management device 10. In this case, the train information management device 10 would be configured to exclude the input data management unit 14, the operation mode management unit 15, and the variable selection unit 16 from the configuration illustrated in FIG. 7. The input data transmission unit 22 of the test terminal device 20 sends input data to the data management unit 13. In the train information management device 10, however, the computation processing units 11B to 11D perform a usual operation, thereby causing the values of the variables p, q, and r stored in the data management unit 13 to be overwritten with output data generated through the usual operation of the computation processing units 11B to 11D. In such case, it would be indeterminable whether the values of the variables p, q, and r for use by the computation processing unit 11A are values sent from the input data transmission unit 22 or values output from the computation processing units 11B to 11D. This would prevent the test conduction management unit 21 of the test terminal device 20 from correctly determining whether the computation processing unit 11A of the train information management device 10 is operating as expected even when the value of the variable s is obtained. A method is conceivable to stop computation processing of the computation processing units 11B to 11D to cause the input data sent from the input data transmission unit 22 to be used as the values of the variables p, q, and r for use by the computation processing unit 11A. This will however need modification of the software under test for purposes of testing, which will be time consuming and require effort, and moreover, prevent guaranteeing the sameness between the software resulting from the modification and the software under test.

In contrast, in the present embodiment, the train information management device 10 includes the input data management unit 14, the operation mode management unit 15, and the variable selection unit 16, and thereby allows a test to be conducted for each computation processing unit 11 under test without changing the configuration of the software under test. In addition, the train information management device 10 is capable of returning to normal mode even when connection between the train information management device 10 and the test terminal device 20 is unintentionally disconnected.

Note that the test terminal device 20 may be made unconnected to the intra-train network 30 when no test is conducted on the train information management device 10. Similarly, the train information management device 10 may be made unconnected to the test communication line 40 when no test is conducted by the test terminal device 20. This can prevent the train information management device 10 from unexpectedly turning into test mode.

A hardware configuration of the train information management device 10 according to the first embodiment will next be described. In the train information management device 10, the computation processing unit 11, the data acquiring and setting unit 12, the data management unit 13, the input data management unit 14, the operation mode management unit 15, and the variable selection unit 16 are implemented in a processing circuitry. The processing circuitry may be a combination of a memory storing a program and a processor that executes the program stored in the memory, or may be a dedicated hardware element. The processing circuitry is also called control circuit.

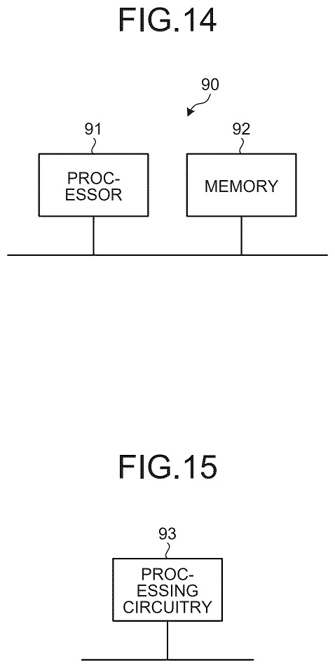

FIG. 14 is a diagram illustrating an example of configuration of a processing circuitry 90, which implements the train information management device 10 according to the first embodiment, when the processing circuitry is implemented by a processor 91 and a memory 92. The processing circuitry 90 illustrated in FIG. 14 is a control circuit, and includes the processor 91 and the memory 92. When the processing circuitry 90 includes the processor 91 and the memory 92, each functionality of the processing circuitry 90 is implemented in software, firmware, or a combination of software and firmware. The software or firmware is described in the form of a program, and is stored in the memory 92. Each functionality is implemented in the processing circuitry 90 in such a manner that the processor 91 reads and executes a program stored in the memory 92. That is, the processing circuitry 90 includes the memory 92 for storing a program that causes processing of the train information management device 10 to be performed. It can also be said that this program is a program for causing the train information management device 10 to perform each functionality to be provided by the processing circuitry 90. This program may be provided using a storage medium storing the program, or may be provided using another means such as a communication medium.

It can also be said that the foregoing program is a program that causes the train information management device 10 to perform a first step in which the data management unit 13 stores a first combination, the first combination including a variable name or information that enables identification of a variable and a value of a first variable, the value of the first variable being a value of the variable, a second step in which the input data management unit 14 stores a second combination, the second combination being obtained from the test terminal device 20 and including the variable name or information that enables identification of the variable and a value of a second variable, the value of the second variable being the value of the variable, a third step in which the operation mode management unit 15 manages an operation mode of the train information management device 10, a fourth step in which the variable selection unit 16 selects, based on the operation mode, either the value of the first variable or the value of the second variable as the value of the variable, and a fifth step in which the data acquiring and setting unit 12 specifies the variable name or the information that enables identification of the variable to the variable selection unit 16, obtains, from the variable selection unit 16, the value of the variable selected, and sets the value of the variable obtained, to the computation processing unit 11.

In this respect, the processor 91 is, for example, a central processing unit (CPU), a processing unit, a computing unit, a microprocessor, a microcomputer, a digital signal processor (DSP), or the like. In addition, the memory 92 is, for example, a non-volatile or volatile semiconductor memory such as a random access memory (RAM), a read-only memory (ROM), a flash memory, an erasable programmable ROM (EPROM), or an electrically erasable programmable ROM (EEPROM) (registered trademark) ; a magnetic disk, a flexible disk, an optical disk, a compact disc, a MiniDisc, a digital versatile disc (DVD), or the like.

FIG. 15 is a diagram illustrating an example of configuration of a processing circuitry 93, which implements the train information management device 10 according to the first embodiment, when the processing circuitry is formed using a dedicated hardware element. The processing circuitry 93 illustrated in FIG. 15 is, for example, a single circuit, a set of multiple circuits, a programmed processor, a parallel programmed processor, an application specific integrated circuit (ASIC), a field programmable gate array (FPGA), or a combination thereof.

The processing circuitry 93 may be implemented partially in a dedicated hardware element and partially in software or firmware. Thus, the processing circuitry 93 can implement each functionality described above by a dedicated hardware element, software, firmware, or a combination thereof.

The test terminal device 20 has a similar hardware configuration. In the test terminal device 20, the input data transmission unit 22 is an interface capable of sending input data to the train information management device 10. The operation mode instruction unit 23 is an interface capable of notifying the train information management device 10 of an operation mode. The test conduction management unit 21 is implemented in a processing circuitry. The processing circuitry may be a combination of a memory storing a program and a processor that executes the program stored in the memory, or may be a dedicated hardware element. The processing circuitry is also called control circuit.

As described above, according to the present embodiment, the train information management device 10 allows a test to be conducted for each function under test, that is, for each of the computation processing units 11, without changing the configuration of software under test. In addition, the train information management device 10 is capable of returning to normal mode even when connection between the train information management device 10 and the test terminal device 20 is unintentionally disconnected.

The train information management device 10 is also usable in a case where the operation mode needs to be returned to normal mode, such as, for example, during a test performed with the train information management device 10 installed on the train 1 in a vehicle factory. Thus, the train information management device 10 is capable of conducting a desired test without changing the configuration of software under test and without affecting the operation of the train 1.

### Second Embodiment

The configuration of the input data management unit 14 of the first embodiment requires the input data management unit 14 to have a storage area having a same capacity as the capacity of the data management unit 13. The data management unit 13 stores all the variables to be processed by the train information management device 10, whereas the computation processing unit 11 under test uses a part of the types of variables as the input data during a test. That is, merely a part of the variables stored in the input data management unit 14 are used in an actual test. In a second embodiment, the input data management unit 14 accordingly has a capacity less than the capacity of the data management unit 13 in the train information management device 10.

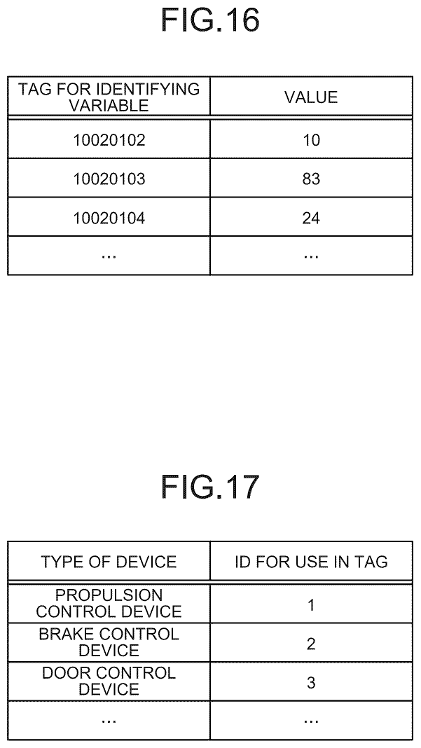

In the second embodiment, a block diagram for illustrating the configurations of the train information management device 10 and of the test terminal device 20 will be similar to the block diagram of FIG. 4 illustrating the configurations of the train information management device 10 and of the test terminal device 20 of the first embodiment. In contrast to the first embodiment, in which a variable name is used for identification of a variable, a tag is used instead for identification of a variable in the second embodiment. FIG. 16 is a diagram illustrating an illustrative image of variables stored in the input data management unit 14 of the train information management device 10 according to the second embodiment. In the second embodiment, the input data management unit 14 stores the input data received from the input data transmission unit 22 of the test terminal device 20 in a form of combinations each including a tag for identifying a variable and a value of the variable. A tag for identifying a variable is information that enables identification of a variable. Note that the input data transmission unit 22 is configured to send combinations each including a tag for identifying a variable and a value of the variable as the input data to be sent to the input data management unit 14. The input data management unit 14 can specify an address in the storage area of the input data management unit 14 using the tag.

When the operation mode of the train information management device 10 is test mode, in a process of obtaining, for example, a value of the variable p2, the variable selection unit 16 of the train information management device 10 searches the storage area of the input data management unit 14 using a tag associated with the variable p2. When the searched-for tag exists in the storage area of the input data management unit 14, the variable selection unit 16 selects and obtains the value of the variable paired with that tag from the input data management unit 14. When the searched-for tag does not exist in the storage area of the input data management unit 14, the variable selection unit 16 selects and obtains the value of the variable paired with that tag from the data management unit 13.

In the second embodiment, the input data management unit 14 stores only combinations each including a tag and a value of a variable, which are the input data sent from the input data transmission unit 22 of the test terminal device 20. The variable selection unit 16 selects and obtains the value of the variable associated with each tag not stored in the input data management unit 14 from the data management unit 13 even when the operation mode of the train information management device 10 is test mode. This eliminates the need for the input data management unit 14 to copy the values of corresponding variables from the data management unit 13 when the operation mode has changed from normal mode to test mode, which is needed in the first embodiment.

A method for identifying a variable in the second embodiment will next be described. Information obtained from monitoring of a device managed by the train information management device 10, command information with respect to that device, and the like are processed in a form of variables. Monitoring information, command information, and the like with respect to devices of a same type are processed in terms of a same type of information, i.e., a same set of variables. Thus, identification of the type of device and then further identification of a variable processed for that type of device enables identification of the type of variable. In addition, devices are installed on vehicles that form the train 1. A same type of multiple devices may be installed on a single vehicle. A device of a specific type is thus designated by a vehicle number that identifies a vehicle and by a serial number in the train 1. In view of the foregoing points in combination, a variable to be processed in association with the train 1 is identifiable by parameters of a type of device, a vehicle number, a serial number in the vehicle, and a variable type.

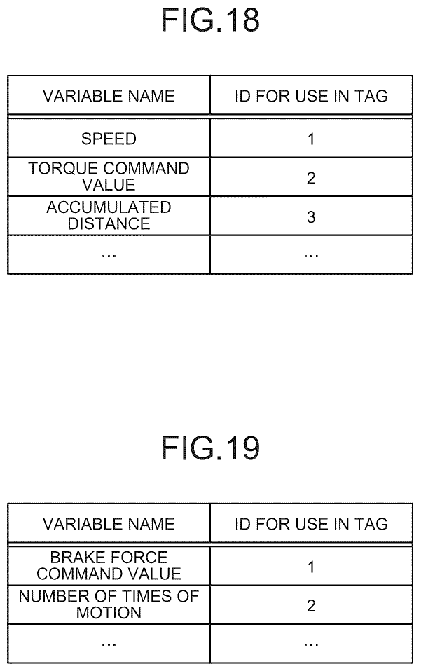

A method for converting a variable into a tag will next be described. To convert the foregoing parameters into a tag, an ID for use in the tag is determined for the type of device and for the variable type of each device. FIG. 17 is a diagram illustrating an example of relationships between types of devices and IDs for use in the tag, where the type of device is a parameter used in the tag processed by the train information management device 10 according to the second embodiment. FIG. 18 is a diagram illustrating an example of relationships between variable names associated with the propulsion control device 2 and IDs for use in the tag, where the variable name is a parameter used in the tag processed by the train information management device 10 according to the second embodiment. FIG. 19 is a diagram illustrating an example of relationships between variable names associated with the brake control device 4 and IDs for use in the tag, where the variable name is a parameter used in the tag processed by the train information management device 10 according to the second embodiment. In FIG. 17, an ID for use in the tag is defined for each type of device. In FIG. 18, an ID for use in the tag is defined for each variable name associated with the propulsion control device 2, which is one of devices. In FIG. 19, an ID for use in the tag is defined for each variable name associated with the brake control device 4, which is one of devices. As illustrated in FIG. 17, the IDs for use in the tag differ from one another depending on the type of device, thereby allowing a same ID to be used as an ID for use in the tag associated with a variable name for each corresponding device as illustrated in FIGS. 18 and 19.

A method of forming a tag will next be described. For example, a tag can be generated from a combination of parameters digitized with the foregoing four IDs. The amount of information to be allocated can be varied depending on the range of specifiable value of each parameter. Although a tag can be given any length, a specific case of 32-bit length will be described below in view of factors such as the variables to be processed by the train information management device 10 and process operability.

For example, method #1 is a method to allocate eight bits to each parameter. That is, eight bits are allocated for the type of device, eight bits are allocated for the vehicle number, eight bits are allocated for the serial number in the vehicle, and eight bits are allocated for the variable type. The tag in this case is expressed as Equation (1).

Tag=(type of device)×2²⁴+(vehicle number)×2¹⁶+(serial number in vehicle)×2⁸+(variable type) . . . (1)

A configuration as expressed by Equation (1) provides high readability by using hexadecimal notation. Note that allocation of a same number of bits to each parameter may result in excess and/or deficiency in the value range of the parameter. For example, the value range may be insufficient for the variable type, and the value range may be excessive for the vehicle number.

Next, method #2 is a method to allocate the number of bits taking into account the amount of information required for each parameter. For example, six bits are allocated for the type of device, seven bits are allocated for the vehicle number, five bits are allocated for the serial number in the vehicle, and 14 bits are allocated for the variable type. The tag in this case is expressed as Equation (2).

Tag=(type of device)×2²⁶+(vehicle number)×2¹⁹+(serial number in vehicle)×2¹⁴+(variable type) . . . (2)

Note that the foregoing allocation is by way of example, and is not limited thereto. Method #2 allows allocation of a number of bits depending on the target to be processed.

In this respect, the variable selection unit 16 needs to search the information stored in the input data management unit 14 using a tag associated with the variable p2 when the value of the variable p2 is to be obtained in test mode. Linear search to sequentially check all the entries requires a longer search time in proportion as the number of entries increases. As such, the variable selection unit 16 can increase the speed of tag search by employing, for example, a common technique called hash search.

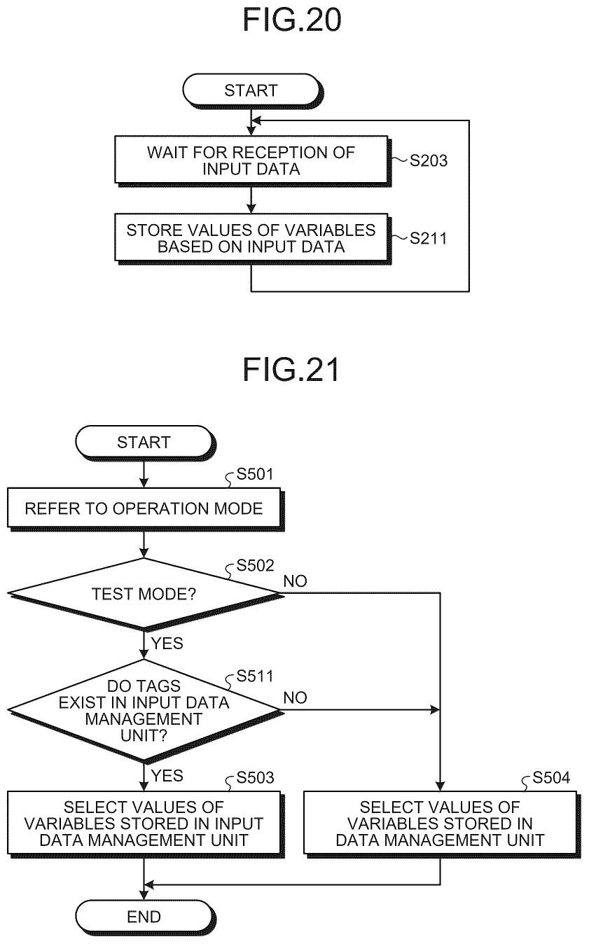

An operation of the train information management device 10 according to the second embodiment will next be described. Note that the operation of the test terminal device 20 will be described in the context of use of input data including combinations each including a tag and a value of a variable of the second embodiment, different from combinations each including a variable name and a value of a variable of the first embodiment. The flow of operation itself is, however, similar, and detailed description will be omitted. FIG. 20 is a flowchart illustrating an operation of the input data management unit 14 of the train information management device 10 according to the second embodiment. FIG. 21 is a flowchart illustrating an operation of the variable selection unit 16 of the train information management device 10 according to the second embodiment. Note that the operation mode management unit 15, the computation processing unit 11, and the data acquiring and setting unit 12 of the train information management device 10 operate similarly to the operation mode management unit 15, the computation processing unit 11, and the data acquiring and setting unit 12 in the first embodiment.

When the train information management device 10 is in test mode, the input data management unit 14 of the train information management device 10 waits for reception of the input data from the input data transmission unit 22 of the test terminal device 20 (step S203), and stores values of the variables based on the input data sent from the input data transmission unit 22 of the test terminal device 20 (step S211). Specifically, the input data management unit 14 stores the input data, i.e., the combinations of tags and the values of the variables.

The computation processing unit 11A specifies variable names to the data acquiring and setting unit 12, and requests the values of the variables p, q, and r as the input data (step S301).

The data acquiring and setting unit 12 specifies variable names to the variable selection unit 16, and requests the values of the variables p, q, and r (step S401).

When the variable names are specified and the values of the variables p, q, and r are requested from the data acquiring and setting unit 12, the variable selection unit 16 refers to the operation mode of the train information management device 10 managed by the operation mode management unit 15 (step S501). When the train information management device 10 is in test mode (step S502: Yes), the variable selection unit 16 searches the input data management unit 14 to check whether the tags associated with the respective variables exist (step S511). When the tags associated with the respective variables exist in the input data management unit 14 (step S511: Yes), the variable selection unit 16 selects the values of the variables p2, q2, and r2 stored in the input data management unit 14 as the values of the variables p, q, and r (step S503). When the tags associated with the respective variables do not exist in the input data management unit 14 (step S511: No), or when the train information management device 10 is in normal mode, the variable selection unit 16 selects the values of the variables p, q, and r stored in the data management unit 13 as the values of the variables p, q, and r (step S504).

The operations of the train information management device 10 and of the test terminal device 20 thereafter are similar to the corresponding operations in the first embodiment.

As described above, in the second embodiment, the data management unit 13 stores a first combination including information that enables identification of a variable and a value of a first variable, where the information that enables identification of a variable is a tag for identifying a variable, and the value of the first variable is the value of the variable. The input data management unit 14 stores only a second combination obtained from the test terminal device 20 and including information that enables identification of a variable and a value of a second variable, which is the value of the variable. The data acquiring and setting unit 12 specifies information that enables identification of a variable to the variable selection unit 16, obtains, from the variable selection unit 16, a value of the variable selected, and sets the value of the variable obtained, to the computation processing unit 11. When the operation mode is test mode, the variable selection unit 16 conducts a search to check whether the input data management unit 14 stores the second combination corresponding to the information that enables identification of a variable, specified by the data acquiring and setting unit 12. The variable selection unit 16 selects the value of the second variable from the input data management unit 14 when that second combination is stored, and selects, from the data management unit 13, the value of the first variable associated with the information that enables identification of a variable, specified by the data acquiring and setting unit 12 when that second combination is not stored.

Note that, in the test terminal device 20, the test conduction management unit 21 stores the second combination including information that enables identification of a variable and a value of the second variable, where the value of the second variable is a value of the variable for use in computation processing performed in a test of the train information management device 10, and the test conduction management unit 21 controls the test of the train information management device 10.

As described above, according to the present embodiment, the input data management unit 14 in the train information management device 10 forms a tag taking into account the train-specific data structure, and manages only the combinations each including a tag and a value of a variable, where the tag is associated with a variable name of the variable to be included in the input data to the computation processing unit 11 under test. This enables the train information management device 10 to manage the input data for use in a test, using a memory having a smaller capacity, and to perform higher-speed access than when the input data management unit 14 manages the entire data.

### Third Embodiment

In the first embodiment and the second embodiment, the train information management device 10 and the test terminal device 20 are connected to each other by the intra-train network 30 and by the test communication line 40. A third embodiment will be described with respect to a configuration in which the test communication line 40 has been removed from the train information management device testing system 50.

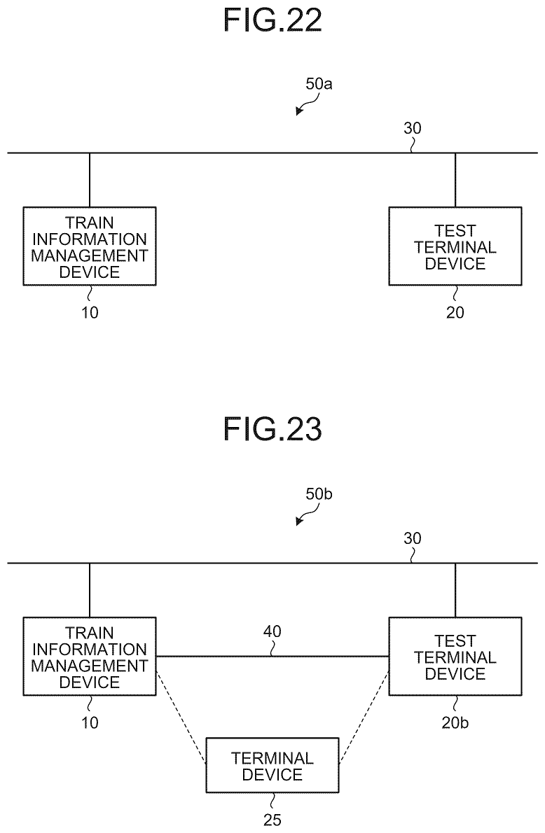

FIG. 22 is a diagram illustrating an example configuration of a train information management device testing system 50a according to the third embodiment. The train information management device testing system 50a includes the train information management device 10, the test terminal device 20, and the intra-train network 30. In the third embodiment, the train information management device 10 and the test terminal device 20 are configured similarly to the train information management device 10 and the test terminal device 20 in the first embodiment except that, in the third embodiment, the input data transmission unit 22 of the test terminal device 20 and the input data management unit 14 of the train information management device 10 communicate with each other, and the operation mode instruction unit 23 of the test terminal device 20 and the operation mode management unit 15 of the train information management device 10 communicate with each other, via the intra-train network 30.

This eliminates the need for the train information management device testing system 50a to individually provide the test communication line 40, thereby allowing reduction in the number of network interfaces on the train information management device 10 and on the test terminal device 20 from two to one. The train information management device testing system 50a can thereby be configured more simply than the train information management device testing system 50 of the first embodiment and of the second embodiment.

### Fourth Embodiment

In the first through third embodiments, the test terminal device 20 notifies the train information management device 10 of the operation mode. A fourth embodiment will be described with respect to a case in which the train information management device 10 is notified of the operation mode from outside the train information management device 10 and outside the test terminal device.

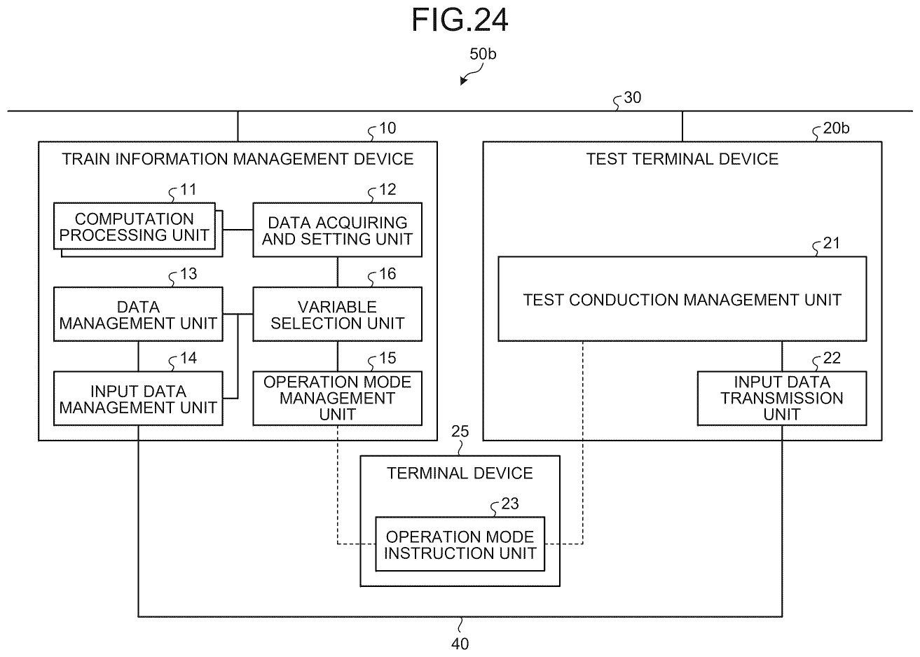

FIG. 23 is a diagram illustrating an example configuration of a train information management device testing system 50b according to the fourth embodiment. The train information management device testing system 50b includes the train information management device 10, a test terminal device 20b, a terminal device 25, the intra-train network 30, and the test communication line 40. FIG. 24 is a block diagram illustrating example configurations of the train information management device 10, the test terminal device 20b, and the terminal device 25 according to the fourth embodiment. The train information management device 10 is similar to the train information management device 10 of the first through third embodiments. The terminal device 25 includes the operation mode instruction unit 23. The test terminal device 20b is configured such that the operation mode instruction unit 23 has been removed from the test terminal device 20 illustrated in FIG. 4. The test terminal device 20b, which conducts a test of the train information management device 10, includes the test conduction management unit 21. The test conduction management unit 21 stores second combinations, each including a variable name or information that enables identification of a variable, and a value of a second variable, which is a value of the variable for use in computation processing to be performed when the train information management device 10 is tested. The test conduction management unit 21 thus controls the test of the train information management device 10. The test terminal device 20b also includes the input data transmission unit 22 for sending the second combinations to the train information management device 10.

In the fourth embodiment, the operation mode instruction unit 23 of the terminal device 25 sends a notification of test mode to the train information management device 10. Thus, the terminal device 25 sends, to the train information management device 10, a notification of test mode indicating that a test is being conducted. As described above, the train information management device 10 returns to normal mode when at least the time period T2 has elapsed since a notification of test mode has no longer been received. This eliminates the need for the operation mode instruction unit 23 of the terminal device 25 to send a notification of normal mode when the train information management device 10 is not tested.

In the first embodiment, the test conduction management unit 21 of the test terminal device 20 receives an instruction to start a test of the train information management device 10 from a maintenance person or the like of the railroad company that operates the train 1. In the fourth embodiment, the test conduction management unit 21 of the test terminal device 20b receives an instruction to start a test of the train information management device 10 through an instruction from the operation mode instruction unit 23 of the terminal device 25. In the fourth embodiment, for example, a maintenance person or the like of the railroad company that operates the train 1 operates the terminal device 25. This enables the train information management device testing system 50b to operate similarly to the train information management device testing system 50 of the first embodiment and the like.

In the fourth embodiment, the terminal device 25 capable of sending a notification of the operation mode sends a notification of test mode with a predetermined period, and when the operation mode management unit 15 receives the notification of test mode, the operation mode management unit 15 maintains the operation mode of the train information management device 10 at test mode for a predetermined time longer than one period of the predetermined period.

Note that during running of the train 1 and/or during operation of the train 1, the train information management device 10 may ignore a notification of test mode from the terminal device 25. This can prevent the train information management device 10 from unexpectedly turning into test mode.

A hardware configuration of the test terminal device 20b will next be described. In the test terminal device 20b, the input data transmission unit 22 is an interface capable of sending input data to the train information management device 10. The test conduction management unit 21 is implemented in a processing circuitry. The processing circuitry may be a combination of a memory storing a program and a processor that executes the program stored in the memory, or may be a dedicated hardware element. The processing circuitry is also called control circuit. A hardware configuration of the terminal device 25 will next be described. In the terminal device 25, the operation mode instruction unit 23 is an interface capable of notifying the train information management device 10 of the operation mode.

As described above, according to the present embodiment, the terminal device 25 including the operation mode instruction unit 23 notifies the train information management device 10 and the test terminal device 20b that the operation mode is test mode. Such operation can also provide an advantage similar to the advantages such as the advantage of the first embodiment.

The configurations described in the foregoing embodiments are merely examples. These configurations may be combined with another known technology, and configurations of different embodiments may be combined together. Moreover, part of such configurations may be omitted and/or modified without departing from the spirit thereof.

### Reference Signs List

1 train; 2 propulsion control device; 3 door control device; 4 brake control device; 10 train information management device; 11, 11A, 11B, 11C, 11D computation processing unit; 12 data acquiring and setting unit; 13 data management unit; 14 input data management unit; 15 operation mode management unit; 16 variable selection unit; 20, 20b test terminal device; 21 test conduction management unit; 22 input data transmission unit; 23 operation mode instruction unit; 25 terminal device; 30 intra-train network; 40 test communication line; 50, 50a, 50b train information management device testing system.

1. A train information management device that undergoes a test conducted by a test terminal, the train information management device comprising:
at least one computation processing circuitry to perform computation processing using a value of a variable;
a data management circuitry to store a first combination, as input data to be provided to the computation processing circuitry, the first combination including a variable name or information that enables identification of a variable and a value of a first variable, the value of the first variable being the value of the variable;
an input data management circuitry to store a second combination, as input data to be provided to the computation processing circuitry, the second combination being obtained from the test terminal and including the variable name or the information that enables identification of the variable and a value of a second variable, the value of the second variable being the value of the variable;
an operation mode management circuitry to manage an operation mode of the train information management device;
a variable selection circuitry to select, based on the operation mode, either the value of the first variable or the value of the second variable as the value of the variable; and
a data acquiring and setting circuitry to specify the variable name or the information that enables identification of the variable to the variable selection circuitry, to obtain, from the variable selection circuitry, the value of the variable selected, and to set the value of the variable obtained, to the computation processing circuitry.

2. The train information management device according to claim 1, wherein
the operation mode management circuitry receives a notification of a test mode or a notification of a normal mode as a notification of the operation mode of the train information management device, the test mode being an operation mode when the test is conducted, the normal mode being an operation mode when the test is not conducted, and
the variable selection circuitry selects the value of the first variable stored in the data management circuitry as the value of the variable when the train information management device is in the normal mode, and selects the value of the second variable stored in the input data management circuitry as the value of the variable when the train information management device is in the test mode.

3. The train information management device according to claim 2, wherein
either the test terminal or a terminal capable of sending a notification of the operation mode sends the notification of the test mode with a predetermined period, and
when the operation mode management circuitry receives the notification of the test mode, the operation mode management circuitry maintains the operation mode of the train information management device at the test mode for a predetermined time longer than one period of the predetermined period.

4. The train information management device according to claim 2, wherein
when the operation mode has changed from the normal mode to the test mode, a combination of the variable name and a value of the variable other than the second combination obtained from the test terminal is obtained and stored in such a manner that the input data management circuitry obtains the first combination from the data management circuitry and stores the first combination, and
when the operation mode is the test mode, the variable selection circuitry either the value of the second variable stored in the input data management circuitry or the value of the first variable.

5. The train information management device according to claim 2, wherein
the input data management circuitry stores only the second combination, obtained from the test terminal and including the information that enables identification of the variable and the value of the second variable, and
when the operation mode is the test mode, the variable selection circuitry conducts a search to check whether the input data management circuitry stores the second combination corresponding to the information that enables identification of the variable, specified by the data acquiring and setting circuitry, and the variable selection circuitry selects the value of the second variable from the input data management unit circuitry when the second combination is stored, and selects, from the data management circuitry, the value of the first variable associated with the information that enables identification of the variable specified when the second combination is not stored.

6. The train information management device according to claim 1, wherein
when the computation processing circuitry performs computation processing using the value of the second variable as the value of the variable, the computation processing circuitry sets a result of the computation processing to a variable from which the test terminal can obtain information of a value.

7. A test terminal for conducting a test of the train information management device according to claim 1, the test terminal comprising:
a test conduction management circuitry to store a second combination to control the test of the train information management device, the second combination including a variable name or information that enables identification of a variable and a value of a second variable, the value of the second variable being a value of a variable for use in computation processing performed in the test of the train information management device;
an input data transmission circuitry to send the second combination to the train information management device; and
an operation mode instruction circuitry to provide the train information management device with a notification of a test mode indicating that a test is being conducted, the notification to be provided when the test conduction management circuitry tests the train information management device.

8. A train information management device testing system comprising:
a train information management device that undergoes a test conducted by a test terminal, including:
at least one computation circuitry to perform computation processing using a value of a variable;
a data management circuitry to store a first combination, as input data to be provided to the computation processing circuitry, the first combination including a variable name or information that enables identification of a variable and a value of a first variable, the value of the first variable being the value of the variable;
an input data management circuitry to store a second combination, as input data to be provided to the computation processing circuitry, the second combination being obtained from the test terminal and including the variable name or the information that enables identification of the variable and a value of a second variable, the value of the second variable being the value of the variable;
an operation mode management circuitry to manage an operation mode of the train information management device;
a variable selection circuitry to select, based on the operation mode, either the value of the first variable or the value of the second variable as the value of the variable; and
a data acquiring and setting circuitry to specify the variable name or the information that enables identification of the variable to the variable selection circuitry, to obtain, from the variable selection circuitry, the value of the variable selected, and to set the value of the variable obtained, to the computation processing circuitry; and
the test terminal device-according to claim 7.

9. A train information management device testing system comprising:
the train information management device according to claim 1;
the test terminal for conducting a test of a train information management device, the test terminal including a test conduction management circuitry to store a second combination to control the test of the train information management device, and an input data transmission circuitry to send the second combination to the train information management device, the second combination including a variable name or information that enables identification of a variable and a value of a second variable, the value of the second variable being a value of a variable for use in computation processing performed in the test of the train information management device; and
a terminal to provide the train information management device with a notification of a test mode indicating that a test is being conducted.

10. A test method for a train information management device that undergoes a test conducted by a test terminal, the test method comprising:
storing a first combination by a data management, as input data to be provided to a computation processing circuitry, the first combination including a variable name or information that enables identification of a variable and a value of a first variable, the value of the first variable being a value of a variable;
storing a second combination by an input data management circuitry, as input data to be provided to the computation processing circuitry the second combination being obtained from the test terminal and including the variable name or the information that enables identification of the variable and a value of a second variable, the value of the second variable being the value of the variable;
managing an operation mode of the train information management device by an operation mode management circuitry;
selecting by a variable selection circuitry, based on the operation mode, either the value of the first variable or the value of the second variable as the value of the variable;
specifying the variable name or the information that enables identification of the variable to the variable selection circuitry, obtaining, from the variable selection circuitry, the value of the variable selected, and setting the value of the variable obtained, to the computation processing circuitry, by a data acquiring and setting circuitry; and
performing computation processing using the value of the variable by the at least one computation processing circuitry.

11. The test method according to claim 10, wherein
in managing the operation mode of the train information management device, the operation mode management circuitry receives a notification of a test mode or a notification of a normal mode as a notification of the operation mode of the train information management device, the test mode being an operation mode when the test is conducted, the normal mode being an operation mode when the test is not conducted, and
in selecting either the value of the first variable or the value of the second variable, the variable selection circuitry selects the value of the first variable stored in the data management circuitry as the value of the variable when the train information management device is in the normal mode, and selects the value of the second variable stored in the input data management circuitry as the value of the variable when the train information management device is in the test mode.

12. The test method according to claim 11, wherein
either the test terminal or a terminal capable of sending a notification of the operation mode sends the notification of the test mode with a predetermined period, and
in managing the operation mode of the train management device, when the operation mode management circuitry receives the notification of the test mode, the operation mode management circuitry maintains the operation mode of the train information management device at the test mode for a predetermined time longer than one period of the predetermined period.

13. The test method according to claim 11, wherein
in storing the second combination, when the operation mode has changed from the normal mode to the test mode, a combination of the variable name and a value of the variable other than the second combination obtained from the test terminal device is obtained and stored in such a manner that the input data management circuitry obtains the first combination from the data management circuitry and stores the first combination, and
in selecting either the value of the first variable or the value of the second variable, when the operation mode is the test mode, the variable selection circuitry selects either the value of the second variable stored in the input data management circuitry or the value of the first variable.

14. The test method according to claim 11, wherein
in storing the second combination, the input data management circuitry stores only the second combination, obtained from the test terminal and including the information that enables identification of the variable and the value of the second variable, and
in selecting either the value of the first variable or the value of the second variable, when the operation mode is the test mode, the variable selection circuitry conducts a search to check whether the input data management circuitry stores the second combination corresponding to the information that enables identification of the variable, specified by the data acquiring and setting circuitry, and the variable selection selects the value of the second variable from the input data management circuitry when the second combination is stored, and selects, from the data management circuitry, the value of the first variable associated with the information that enables identification of the variable specified when the second combination is not stored.

15. The test method according claim 10, wherein
in performing the computation processing, when the computation processing circuitry performs computation processing using the value of the second variable as the value of the variable, the computation processing circuitry sets a result of the computation processing to a variable from which the test terminal device can obtain information of a value.
